(19) United States
(12) Patent Application Publication
(10) Pub. No.: US 2025/0019901 A1
(43) Pub. Date: Jan. 16, 2025

(54) PLASTIC FREE PACKAGING AND USE OF THE PACKAGING FOR MORTARS AND FERTILIZERS

(71) Applicant: Klabin S.A., São Paulo (BR)

(72) Inventors: Guilherme Giesel, Lages (BR); Gustavo Esmério da Silva, Lages (BR); Marcio Jose Da Silva, Lages (BR); Franck de Sousa Ferreira, Lages (BR); Alexandro Wehmuth, Lages (BR); Aluisio Ramos Guedes, Lages (BR); Antonio Alexandre Souza, Lages (BR); Erico De Castro Ebeling, São Paulo (BR)

(21) Appl. No.: 18/770,361

(22) Filed: Jul. 11, 2024

(30) Foreign Application Priority Data
Jul. 11, 2023 (BR) 102023013861-6

(51) Int. Cl. B32B 29/00; B32B 37/12

(52) U.S. Cl. CPC B32B 29/005; B32B 37/12; B32B 2250/02; B32B 2255/12; B32B 2307/582; B32B 2307/7246; B32B 2317/122

(57) ABSTRACT

The present invention is related, in one embodiment, to a paper packaging, totally free of plastic film, with water vapor barrier and tear resistance, whereby it may present perforations in specific regions. The packaging of the present invention further presents, in one embodiment, a sheet coated on the external face thereof with a water repellent agent. The packaging of the present invention presents the property of increasing the shelf life of the stored material.

### CROSS-REFERENCE TO RELATED APPLICATIONS

This application claims priority to Brazilian Patent Application No. BR102023013861-6, filed Jul. 11, 2023, which is hereby incorporated by reference in its entirety.

### FIELD OF THE INVENTION

The present invention is related to a paper packaging, totally free of plastic film, with water vapor barrier and tear resistance. The packaging of the present invention can be applied in several areas, among them the area of cements, specifically for packaging mortars, and agricultural, for packaging fertilizers. The packaging of the present invention presents the property of increasing the storage life span (shelf life) of the material.

### BACKGROUND OF THE INVENTION

The use of plastic packaging has had an increasing growth in the last years. Despite having brought a revolution to the consumer in terms of advantages in storage and preservation of the quality of the packaged products, the disposal of said plastic packaging caused damages up to then unimaginable to the environment.

An alternative to minimize the environmental damage consists of minimizing the use of packaging plastic films, while still maintaining the conservation quality of the products.

The packaging used in the construction area for mortars is conventionally produced based on plastic, whereby they may comprise 100% plastic or comprise at least one plastic film layer between two sheets of paper.

The packaging usually used for applying to mortars is produced from a polymer, such as low-density polyethylene. Currently, there is usually inserted in the paper packaging a high-density polyethylene film layer between two sheets of paper.

It is verified that the thickness of the high-density polyethylene layer in a paper packaging can vary from 8 um to 40 u and can also have different characteristics such as perforations, perforations and tears, tears and smooth. All these variables influence the barrier provided to the packaged product.

Although the plastic films used present barrier levels to the passage of water vapor adequate for the application, they present high resistance to the passage of air, being necessary the use of perforations or tears so as to ensure the air outlet with the necessary flow to guarantee the performance of the cement material packaging machines, wherein the air is used as a vehicle for transport of products. This perforation of the plastic film reduces the barrier capacity thereof.

The packaging usually used for storage of fertilizers is normally produced with 100% of petrochemical based products, whereby the most common are plastic and/or laminated raffia, since they have the characteristic of acting as a barrier to water and to water vapor. The polymers most used in this packaging are low-density polyethylene and polypropylene.

The grammage of the layer of said polymers in a packaging for fertilizers can vary from 150 g/m² to 300 g/m² and can also present different characteristics, such as perforations. All these variables influence the barrier provided to the packaged product.

Thus, it has become a challenge for the companies to develop products which cause less damage to the environment and facilitate recycling of the packaging by replacing plastic and maintaining the quality of the product and with low costs.

Some initiatives have already been made in this sense, document EP0545228 describes a moisture-resistance sack which comprises one or more paper layers, of which one or more layers are coated with a moisture-resistant film containing modified starch and a synthetic material, based on styrene-butadiene copolymer and vinyl acetate acrylate copolymer applied in aqueous dispersion wherein the first drying phase is by shock drying and after drying the film tension is removed by fracturing in a device. Said sack presents a water vapor permeability of approximately 15-30 g/m²/24h. This document does not mention the use of micro perforations in determined regions of the packaging.

Document U.S. Pat. No. 8,603,597 cites as suitable material for a sack layer, a porous sheet wherein at least one of the surfaces thereof is coated with a polyolefin. It does not mention the use of coating agents such as the styrene-butadiene based polymers and/or acrylic esters, and/or waxes.

Document JPH086278 is related to an acrylic emulsion which is applied several times and to an acrylic resin which is laminated on one side of the processed paper to have resistance to water and oil, whereby the acrylic resin is used as a core, and the core periphery is water-soluble. This document describes an acrylic emulsion which must be applied several times to one side of the processed paper, such as cardboard, liner, kraft and recycled paper.

Document WO03010055 is related to a paper sack for packaging for heavyweight materials, such as cement, sugar, flour, animal feed. The sack disclosed has between 3 and 4 layers wherein the outer ply of the sack comprises a kraft paper or modified medium paper (MMP);an intermediate ply of the sack comprises one or two sheets of paper selected from the group consisting of medium paper, dual medium paper (DMP) and MMP; and an inner ply of the sack comprises a sheet of paper selected from the group consisting of DMP, MMP, kraft paper and B kraft paper. The dual medium paper (DMP) is manufactured by laminating two plies of medium paper with a water-soluble binder. The water-soluble binder is a synthetic resin adhesive consisting of ethylenevinylacetate (EVA), polyvinylalcohol (PVA) and acrylic emulsion.

Document EP1884594 has the purpose of providing a stable migration paper which is resistant to high and low molecular weight substances, polar and non-polar. The paper described is formed with a coating based on a dispersion of acrylic or ethylene acrylate polymers or methacrylate polymers, acrylic-styrene-or butadiene-styrene polymers, polyvinyl alcohol, polyurethane, polyvinylidene chlorides or polyester acrylate or their copolymers or mixtures thereof. This document does not mention the use of kraft type paper.

Document U.S. Pat. No. 7,267,743 discloses emulsions prepared from a wax derived from vegetable sources which are used in a variety of applications, such as for coating fibrous cellulosic products, such as paper and wood, to make them moisture resistant, without specifying the use of different layers. According to this document, the wax can be of castor, soybean, palm, corn, cottonseed, rape, canola, sunflower, palm kernel, coconut, crambe, linseed and peanut.

Document EP3351374 describes a laminate comprising a fiber layer formed of cellulose fibers having a fiber width (of 1000 nm or less); a resin layer; and an adhesive layer provided between the fiber layer and the resin layer. The resin layer comprises a polymer of acrylic monomers.

Document JP2985363 is related to a method for manufacturing a moisture resistant packaging material based on paper. Additionally, it refers to a method for producing a moisture proof packaging material using paper as a base material, which can be used for retaining moisture-proofness for a long period of time, directly packaging chemicals, foods and the like. This document does not mention the use of more than one layer in the packaging material.

Document EP3686007 describes a barrier material containing water vapor barrier layer which preferably presents a water repellent for increasing the water vapor barrier property. Examples of the water repellent can include a paraffin-based water repellent mainly containing an alkane compound, a natural fat-based water repellent derived from an animal or plant, such as carnauba wax or lanolin, a silicone-containing water repellent containing silicone or a silicone compound, and a fluorine-containing water repellent containing a fluorine compound. However, this document is restricted to the barrier material, it does not mention packaging for cements and does not cite the use of micro perforations in determined regions of the packaging.

In this manner, there persists the need for developing a packaging which avoids the use of plastic materials and presents similar or superior results to the packaging produced from said materials, particularly in what refers to the storage quality and conservation of the product.

### SUMMARY OF THE INVENTION

The purpose of the present invention consists of providing a paper-based packaging for applying in the construction, agricultural, food, or other areas, which can replace the plastic packaging or totally replace the plastic film normally used in conventional packaging as protection against humidity.

A second objective of the present invention consists of providing paper-based packaging, free of plastic films, facilitating the recycling thereof.

A third objective of the invention consists of providing a paper-based packaging, free of plastic films and which is recyclable, maintaining the quality of the product, equaling or even improving the shelf life of the product, such as mortars or fertilizers, among others, when compared with the packaging currently used.

### BRIEF DESCRIPTION OF THE FIGURES

FIG. 1 illustrates the external sheet of one of the preferred embodiments of the invention, for mortar storage, wherein ‘A’ is the upper bottom, ‘B’ is the lower bottom, ‘C’ is the valve.

FIG. 2 illustrates the inner sheet of one of the preferred embodiments of the invention, for mortar storage, wherein ‘A’ is the upper bottom, ‘B’ is the lower bottom, the area 1 represents the region wherein the coating comprising the water vapor passage barrier agent is present and area 2 represents the region wherein the perforations are present.

FIGS. 3A-B represent the results of mortar storage tests, whereby FIG. 3A indicates an acceptable condition and FIG. 3B indicates a non-acceptable condition.

FIG. 4 illustrates the inner sheet coated with a water vapor passage barrier agent or laminated with a polyethylene film and the external sheet coated with a water repellent agent. The regions indicated with letter “A” are the upper bottom, “B” the lower bottom and “C” is the valve.

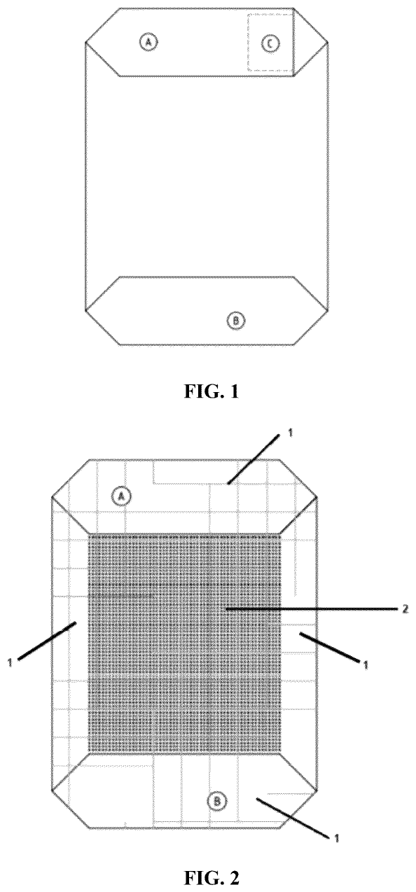

### BRIEF DESCRIPTION OF THE INVENTION

The present invention consists of a packaging comprising one or more paper sheets wherein at least one of these sheets is coated on one or the two faces with a water vapor barrier agent, and/or water repellent agent, for applying in the construction, agriculture, food or other areas, which can replace the plastic packaging or totally replace the plastic film used in conventional packaging as a protection against moisture penetration.

In an embodiment of the present invention, the water barrier agent grants the sheet to which it is applied a water vapor passage rate measured according to ASTM E96-00 norm, less than about 220 g/(m².d). The shelf life of the product packaged in this embodiment of the invention is about 6 months.

In an embodiment of the present invention, the external face of the packaging is optionally coated with a water repellent agent which grants water absorption values according to ISO 535 method lower than about 5 g/m², preferably about 3 g/m² and static friction coefficient according to TAPPI T-549 method between about 0.45 and about 0.90, preferably about 0.55.

In a specific embodiment of the invention, one or more paper sheets present a region with micro or nano-perforations so as to allow the air outlet during bagging.

The packaging of the invention allows achieving advantageous effects in terms of water vapor passage resistance, extending the shelf life of the stored products.

Additionally, the packaging of the present invention for the mortar market provides suitable storage, including increasing the storage shelf life, in a specific embodiment, without using plastic films, so the packaging of the present invention is environmentally friendly.

### DETAILED DESCRIPTION OF THE INVENTION

The present invention consists in providing a packaging which is paper based, free of plastic films, comprising, in a specific embodiment, at least one kraft paper sheet with grammage between about 50 and about 110 g/m², preferably about 60 g/m², wherein at least one sheet is coated, on one or on both faces, with a water vapor barrier passage layer, which comprises about 6 to about 20 g/m², preferably about 10 g/m² vapor barrier agents.

By water vapor barrier agents, it is understood those components which prevent or delay the passage of water vapor on paper, being commonly used acrylic copolymer emulsions, styrenated copolymers, polyurethanes, or amine-and phenolic-based polymers, vegetable resins and waxes, among others and/or mixtures thereof.

In a preferred embodiment of the present invention, said agents are selected from styrene-butadiene based copolymers and/or acrylic esters and/or waxes. Said agents grant a water vapor passage rate measured according to ASTM E96-00 norm, lower than about 220 g/(m².d), preferably about 150 g/(m².d).

The inventors found that the packaging of the present invention, which comprises the sheets coated with the water vapor barrier agents, provide longer storage shelf life to the stored product. The lower the value of the water vapor passage rate provided, the greater the storage shelf life of the stored product and it was possible to achieve, with the packaging of the present invention, suitable water vapor passage rates and which provide longer shelf life to the stored product, without the use of plastic films. In a specific embodiment, the paper comprises a coating with a water vapor barrier agent on one and/or on both faces.

In a specific embodiment, the paper comprises a region from about 10 to about 20 mm at one of the edges of the sheet without applying the water vapor barrier agent to allow adhesion in the tuber-forming stage in the sack making machine.

In an embodiment of the present invention, the paper coated with the water vapor barrier agent contains perforations with hole diameters of about 0.20 mm to about 0.80 mm, preferably about 0.60 mm. These perforations can optionally be distributed throughout the entire sheet and/or optionally in specific regions.

In a preferred embodiment, the packaging of the present invention consists of two sheets of kraft paper, wherein the internal sheet is coated on one of the faces with a water vapor barrier agent, and said internal sheet is glued to the outer sheet with polyvinyl acetate-based adhesive. In a specific embodiment, the water vapor barrier agent can be applied on the internal sheet, the external sheet or on both the internal and/or external sheets.

In another preferred embodiment of the invention, the paper packaging consists of three sheets of kraft paper, whereby the sheet that is coated with the water vapor barrier agent is positioned between the internal and external sheets and it is glued to the external sheet with polyvinyl acetate-based adhesive.

In a specific embodiment, the water vapor barrier agent can be applied on only one sheet, on two sheets and/or on the three sheets, in the internal and/or external faces.

In an embodiment of the present invention, the paper consists of a kraft paper with Longitudinal TEA (Tensile Energy Absorption) measured in accordance with ISO 1924-3:2005 norm greater than about 115 J/m², preferably about 145 J/m².

In a specific embodiment of the invention, the packaging optionally comprises an external sheet coated on the external face thereof with a water repellent agent, which comprises about 2 to about 12 g/m^{2,} preferably about 8 g/m² water repellent agents.

By water repellent agents it is understood those compounds that provide obtaining an impermeable paper, such as acrylic copolymer emulsions, styrene-butadiene copolymers, polyurethanes, polyolefins and waxes. Preferably, there is used an aqueous emulsion of styrenated acrylic copolymers and polyethylene waxes and/or mixtures thereof.

In a preferred embodiment of the present invention, the paper packaging is composed by three sheets, whereby the internal one has a water vapor barrier coating, the intermediary one is composed by paper without the presence of specific coatings, and the external sheet has a water repellent coating. In this specific embodiment, there is no need to perform perforations along the packaging, due to the low air pressure during bagging of the packaged material.

The packaging of the present invention provides adequate protection against humidity penetration, allowing to prolong useful shelf life from about 6 to about 9 months, in comparison with the packaging usually used.

In a preferred embodiment, the stored product is mortar and/or cement. In another preferred embodiment of the invention, the stored product is a fertilizer, in this case the useful shelf life is equal to the packaging usually used, whereby the average time is about 6 months.

A specific embodiment of the present invention is related to the use of the packaging as described in the present invention, for storage of products, such as mortars and/or cements and/or fertilizers.

In an embodiment of the present invention, the water barrier agent and the water repellent agent are applied to the paper by means of a machine known as “air knife coater”, according to usual procedures of the technique which will be promptly recognized by a person skilled in the art. Following said procedure, the packaging is produced as detailed below.

In a specific embodiment, the paper packaging free of plastic films of the present invention has perforations of about 0.20 to about 0.80 mm, preferably about 0.60 mm, on one, two and/or on all the sheets to allow deaeration of the product during the bagging operation. These perforations are performed by the same conventional methods used in common paper packaging.

In a specific embodiment, the packaging of the present invention presents a common valve, usually used in packaging of the type for the process of product bagging. The valve paper usually presents from about 90 g/m² to about 110 g/m². The length of this valve paper can present from about 90 mm to about 140 mm, with an overlapping fold of about 40 mm to about 80 mm with the purpose of reinforcing this part of the packaging.

In a specific embodiment, the packaging of the present invention presents a valve specifically developed for this packaging, being formed by two sheets of paper, wherein one of them has the same coating as the external sheet with water barrier. The valve papers usually present a total sum of about 150 g/m² to about 180 g/m². The length of these valve papers can present from about 130 mm to about 180 mm, with an overlapping fold of about 40 mm to about 80 mm with the purpose of reinforcing this part of the packaging.

In a specific embodiment of the present invention, the packaging is obtained from two sheets of paper, which are uncoiled and converted into sacks. The first step of this process consists of folding and cutting the paper into specified measurements as per the usual practice, next the sheets are glued to the end of the paper in the longitudinal direction, using a commonly used adhesive for this, such as polyvinyl acrylic-based adhesives (PVA), forming tubes at the end of this process.

In this same process, there is carried out or not the perforation of the packaging, which can be altered according to the level of air injection in the bagging process desired, whereby there may be used nano perforations (0.2 to 0.4 mm) or micro perforations (0.5 to 0.8 mm). The perforation can occur throughout all the width and height extension of the sack or only at specific points, as desired. Said perforations can be carried out on any of the sheets.

The second step of the process, with the tube already formed, more folds are made to form the upper and lower bottom, in the sequence there is applied adhesive, for the bottoms to be closed and glued at the end of the process. Next, there is applied one or more papers for forming the valve, at which moment there is also applied an adhesive so that there is adherence between the valve paper and the sack paper. There is also the possibility of paper reinforcements being applied over the sack closure, so that the sack has more resistance in the production process. Whereby, in a specific embodiment of the present invention, the papers of this reinforcement also undergo the application of the water barrier agent.

In the third step of the process, the bags are palletized, stored in greenhouses for humidity control, after achieving a suitable humidity level, the palletized sacks are compacted, optimizing the storage and transportation processes.

In an unexpected manner, it was found by the inventors of the present invention that, by controlling the vapor passage rate of the produced packaging at the levels now specified and disclosed, it is possible to achieve a shelf life that is surprisingly greater relative to the packaging used up to the moment.

The inventors found that, the lower the value of the water vapor passage rate, the longer the useful storage shelf life achieved. It was surprisingly found that the packaging obtained provides a longer useful storage shelf life precisely by presenting lower values of the vapor passage rate.

Another important characteristic to be controlled is the diameter and positioning of the perforations. Controlling this characteristic is important since it directly influences the resistance of the packaging and the useful storage life of the bagged product, since increasing or reducing the number and diameter of the perforations, the water vapor passage is regulated: when the number of perforations increases, the water vapor passage also increases, since the area without barrier is consequently increased. Regarding the position of the perforations, it is essential to preserve the sides without perforations, since when the packaging is piled, these areas are the ones most exposed to environmental water vapor.

The cited characteristics can be controlled by usual procedures of the technology, for example, by means of the number of vapor passage barrier agents applied on the paper and the control of diameter, amount and position of the perforations in the packaging.

The inventors surprisingly found that applying barrier agents in the range of about 6 to about 20 g/m², preferably about 10 g/m², according to the present invention, provided an unexpected increase in the shelf life of the storage of stored products, particularly cements and mortars.

The inventors further found that, in an embodiment of the present invention, applying water repellent agents on the external face of the packaging, in the specified concentrations, applying water vapor barrier agent on the internal face of the packaging equaled the useful storage shelf life of the stored products, particularly fertilizers.

In this context, the inventors found that the packaging manufactured with paper coated with a vapor barrier agent, although it presents a lower water vapor barrier level than that reached with plastic packaging, sufficed to maintain a similar level of protection.

The examples described above make it clear that the packaging according to the present invention obtained surprising results relative to the useful storage shelf life of the products. Said examples serve as an illustration of embodiments of the present invention and must not be understood as limiting same.

Having described examples of embodiments, it must be understood that the scope of the present invention covers other possible variations, being limited only by the contents of the attached claims, there being included therein the possible equivalents.

### EXAMPLE 1

### Storage Shelf Life Test (Shelf Life) of the Packaging for Mortar of the Invention

Kraft paper 60 g/m², having longitudinal TEA of 140 j/m² was coated on one of the faces thereof with dry 15 g/m² of the vapor barrier agent CHT 230 manufactured by CHT Brasil Química Ltda, granting a water vapor passage rate of 140 g/m².d.

### EXAMPLE 2

### Storage Shelf Life Test (Shelf Life) of the packaging for fertilizers of the invention.

The packaging was manufactured using two sheets of kraft sack paper with a grammage of 90g/m², with longitudinal traction resistance of 6.5 kN/m and longitudinal TEA of 262 j/m². The external face of the external sheet was coated with 8 g/m² of AQ3145048 water barrier agent manufactured by Actega do Brasil Tintas e Vernizes Ltda, which granted a Cobb 120 s of 2.5 g/m2 and a static friction coefficient in the longitudinal direction of 0.75 on the coated face. The external face of the internal sheet was coated with 17 g/m² of water vapor barrier agent CHT 230 manufactured by CHT Brasil Química Ltda, granting a water vapor passage rate of 97 g/m².d.

### EXAMPLE 3

### Shelf Life Evaluation Method (Shelf-life) of Bagged Mortar

Objective: Detect the formation of lumps or caking of the bagged mortar, generated by the absorption of humidity of the mortar in the test packaging.

Method: Empty a 20 Kg package of Mortar and pass the entire content thereof through a 0,6 mm granulometric sieve.

Storage Condition: The bagged and palletized sack is stored in an environment sheltered from rain and sunlight. The bagged sack is stored in PBR (1.000 mm×1.200 mm) pallet at temperature and humidity conditions according to the local climate condition.

Frequency: The evaluations were made on the sacks as described in examples 1 and 2, palletized every 30 days, always using a sack from the pallet, as a monthly sample.

Useful storage time: The useful storage time in the storage area for mortars and/or cements can vary from 3, 6, 9 or 12 months, according to the addition of cement to the mortar of each manufacturer. The greater the addition of cement to the mortar, the greater will be the humidity absorption by the mortar.

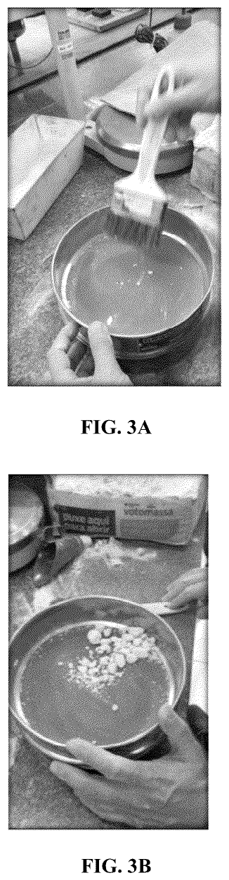

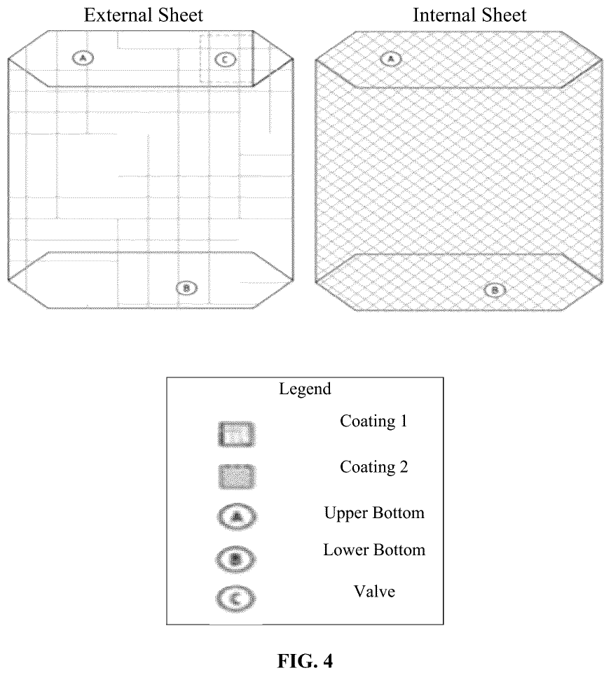

End of Measurement/Closing of Evaluation: When a significant volume (unacceptable condition) of lump retention in the 0.6 mm granulometric sieve is detected, that is, when there are observed stones in the sieve with the specified granulometry, the test is terminated. At this moment, the time found in the previous test is counted, wherein the 0.6 mm granulometry sieve did not retain the evaluated mortar. The “acceptable” and “unacceptable” conditions are illustrated in FIG. 3A and 3B, respectively.

### EXAMPLE 4

### Shelf life Evaluation Method (Shelf-life) of Bagged Fertilizer

Objective: Detect the formation of lumps or caking of the bagged fertilizer, generated by the absorption of humidity of the fertilizer in the test packaging.

Method: Empty a 25 Kg package of Fertilizer and pass all the content thereof through seven granulometry sieves of about 0.5 mm to about 4.8 mm.

Storage Condition: The filled and palletized bag is stored in an environment sheltered from rain and sunlight, additionally wrapped with stretch film and covered with canvas. The bagged sack is stored in PBR (1.000 mm×1.200 mm) pallet at temperature and humidity conditions according to the local climate condition.

Frequency: The evaluations were made on the sacks every 30 days, always using a sack from the pallet, as a monthly sample.

Useful storage life; The useful storage life in the storage area for fertilizers reached up to 6 months, which is the usual time for products of this type.

End of Measurement/Closing of Evaluation: The test was carried out monthly until the cycle of 6 months was complete, which is the fertilizer's requirement. When more than 2% is detected retained in the larger 4.8 mm sieve (unacceptable condition) the test is terminated. At this moment, the time found in the previous test is counted, wherein the 4.8 mm granulometry sieve did not retain the evaluated fertilizer

1. Packaging characterized by the fact that it comprises at least one sheet of kraft paper, coated with a vapor passage barrier agent, comprising from about 6 to about 20 g/m², preferably about 10 g/m² vapor passage barrier agents.

2. Packaging, according to claim 1, characterized by the fact that the vapor passage barrier agents are selected from acrylic copolymer emulsions, styrenated copolymers, polyurethanes, amine and phenolic-based polymers, vegetable resins and waxes and/or mixtures thereof.

3. Packaging, according to claim 2, characterized by the fact that the vapor passage barrier agents are applied on one and/or both faces of the sheet of paper.

4. Packaging, according to claim 3, characterized by the fact that it presents a water vapor passage rate measured according to ASTM E96-00 norm, lower than about 220 g/(m².d), preferably about 150 g/(m².d).

5. Packaging, according to claim 1, characterized by the fact that it presents a region of about 10 to about 20 mm of the paper edge without application of the barrier agent.

6. Packaging, according to claim 1, characterized by the fact that the sheets of kraft paper present grammages between about 50 and about 110 g/m², preferably about 60 g/m².

7. Packaging, according to claim 1, characterized by the fact that it optionally comprises perforations with hole diameters from about 0.20 mm to about 0.80 mm, preferably about 0.60 mm.

8. Packaging, according to claim 7, characterized by the fact that the perforations can optionally be distributed throughout the sheet or optionally in specific regions.

9. Packaging, according to claim 1, characterized by the fact that the sheet coated with a water vapor passage barrier agent is glued to the other sheet with an acetate polyvinyl-based adhesive.

10. Packaging, according to claim 9, characterized by optionally comprising a third sheet of kraft paper, wherein the sheet covered with the water vapor barrier agent is positioned between the internal and external sheets and is glued to the external sheet with acetate polyvinyl-based adhesive.

11. Packaging, according to claim 1, characterized by optionally comprising a coated sheet on the external face thereof with a water repellent agent.

12. Packaging, according to claim 11, characterized by the fact that the water repellent agent is selected from acrylic copolymer emulsions, styrene-butadiene copolymers, polyurethanes, polyolefins and waxes and/or mixtures thereof, preferably aqueous emulsion of acrylic styrenated copolymers, and polyethylene waxes.

13. Packaging, according to claim 12, characterized by the fact that the external sheet coated on the external face thereof with a water repellent agent comprises about 2 to about 12 g/m², preferably about 8 g/m² of water repellent agents.

14. Packaging, according to claim 11, characterized by the fact that it presents water absorption lower than about 5 g/m², preferably about 3 g/m², measured in accordance with ISO 535 method and static friction coefficient according to TAPPI T-549 method between about 0.45 and about 0.90, preferably about 0.55.

15. Use of a packaging as defined above in any of claims 1 to 14, characterized by the fact that it is for product packaging.

16. Use, according to claim 15, characterized by the fact that the products are mortars, cements and/or fertilizers.
